(19) United States
(12) Patent Application Publication
(10) Pub. No.: US 2011/0118964 A1
(43) Pub. Date: May 19, 2011

(54) GLOW PLUG DRIVE CONTROL METHODS

(76) Inventors: Arihito Tanaka, Saitama (JP); Kan Cho, Saitama (JP); Yasuo Toyoshima, Saitama (JP)

(21) Appl. No.: 13/000,948

(22) PCT Filed: Jun. 30, 2009
(86) PCT No.: PCT/JP2009/061949

§ 371 Date: Dec. 22, 2010

(30) Foreign Application Priority Data
Jul. 3, 2008 (JP) 2008-174841

(51) Int. Cl. F02P 19/02

(52) U.S. Cl. 701/113

(57) ABSTRACT

To suppress deterioration caused by thermal stress without sacrificing the required maximum temperature.

At a time when post glow of ceramic glow plugs 50-1 to 50-n ends, when it has been determined that a cooling state inside a combustion chamber of an engine is not in a predetermined strong cooling state for a first predetermined amount of time or longer, post glow energization is stopped (S106, S112), but when it has been determined that the cooling state inside the combustion chamber of the engine is in the predetermined strong cooling state for the first predetermined amount of time or longer, a preset post glow extension voltage-use map is used to obtain a voltage when extending post glow energization, and post glow energization extension is started using that voltage, and thereafter, when it has been determined that the cooling state inside the combustion chamber of the engine is transitioning from the predetermined strong cooling state to an abated state for a second predetermined amount of time or longer, post glow energization extension is stopped (S108, S110), to thereby alleviate thermal stress and suppress ceramic heater deterioration.

### BACKGROUND OF THE INVENTION

1. Field of the Invention

The present invention pertains to methods of controlling the driving of glow plugs that are used mainly to aid the starting of diesel engines and particularly relates to improving reliability by alleviating thermal stress.

2. Description of the Related Art

Conventionally, as glow plug drive control in vehicles, enabling glow plugs to handle a rapid rise in temperature by performing energization control by so-called PWM control has generally been carried out. Moreover, in view of the fact that the cooling state of the glow plugs varies through all of the operating regions of the engine, in order to realize a more appropriate drive state while being exposed to those various cooling states, disposing a glow plug drive voltage correction map that has been created using as parameters various elements such as the outside air temperature, the engine speed, the engine drive torque, and the atmospheric pressure and using that correction map to appropriately correct the glow plug drive voltage resulting from the PWM control has also been carried out.

Further, apart from these control methods, there has also been, for example, a way of thinking of using a resistor circuit called a dropping resistor to optimize the vehicle battery voltage to a voltage lower than the conventional rated voltage to realize a rapid rise in temperature.

Incidentally, in recent years, ceramic glow plugs that use ceramic heaters as heating elements from the standpoint of their rapid heatability and heat resistance required of glow plugs are being heavily used, but because they are in a corrosive environment and exposed to thermally harsh conditions, various proposals have been made from the standpoint of improving heat resistance and suppressing deterioration even more, as disclosed, for example, in JP-A-2004-259610, JP-A-2003-240240, and etc.

However, it has been confirmed by the research of the present inventors that even when ceramic glow plugs are driven by a conventional drive method, in a state where the cooling condition is harsh inside the combustion chamber, that is, in a state where swirl cooling is strong, there is the potential for a large temperature difference to arise between the surface portions of the ceramic heaters and the insides where the heating elements are buried, such that the ceramic heaters become subjected to large thermal stress, which can lead to deterioration of the ceramic heaters, and, in a worst-case scenario, cause annular cracks inside the ceramic heaters and end up shortening the life-span of the ceramic glow plugs.

And yet, the cause of the occurrence of cracks is not clear, and current circumstances are such that the potential for the cracks to occur in a worse-case scenario must be avoided by regulating the maximum temperature of the ceramic glow plugs, which leads to even more trouble, such as a worsening of exhaust gas characteristics at low temperatures and an increase in engine noise resulting from the frequent occurrence of misfiring, and leads to the problem that the inherent advantages of ceramic glow plugs cannot be fully utilized.

### SUMMARY OF THE INVENTION

The present invention has been made in view of the circumstances described above and provides glow plug drive control methods and glow plug drive control systems that can suppress deterioration caused by thermal stress in ceramic heater portions without sacrificing the required maximum temperature.

According to a first aspect of the present invention, there is provided a glow plug drive control method that controls the energization of a glow plug, the glow plug drive control method being configured such that at a time when post glow of the glow plug ends, when it has been determined that a cooling state inside a combustion chamber of an engine is not in a predetermined strong cooling state for a first predetermined amount of time or longer, post glow energization is stopped.

According to a second aspect of the present invention, there is provided a glow plug drive control method that controls the energization of a glow plug, the glow plug drive control method being configured such that at a time when intermediate glow of the glow plug ends, when it has been determined that a cooling state inside a combustion chamber of an engine is not in a predetermined strong cooling state for a third predetermined amount of time or longer, intermediate glow energization is stopped.

According to a third aspect of the present invention, there is provided a glow plug drive control system comprising: an electronic control unit that executes drive control of a glow plug; and an energization circuit that performs energization of the glow plug according to the glow plug drive control executed by the electronic control unit, wherein the electronic control unit is configured such that at a time when post glow of the glow plug ends, when it has been determined that a cooling state inside a combustion chamber of an engine is not in a predetermined strong cooling state for a first predetermined amount of time or longer, the electronic control unit causes the energization circuit to stop post glow energization.

In this configuration, it is suitable for the electronic control unit to also be configured such that at a time when intermediate glow of the glow plug ends, when it has been determined that a cooling state inside a combustion chamber of an engine is not in a predetermined strong cooling state for a third predetermined amount of time or longer, the electronic control unit causes the energization circuit to stop intermediate glow energization.

### BRIEF DESCRIPTION OF THE DRAWINGS

FIG. 1 is a configuration diagram showing an example configuration of a glow plug drive control system to which glow plug drive control methods in an embodiment of the present invention are applied;

FIG. 2 is a sub-routine flowchart showing a procedure of glow plug drive control processing for post glow that is executed by an electronic control unit configuring the glow plug drive control system shown in FIG. 1;

FIG. 3 is a sub-routine flowchart showing a procedure of glow plug drive control processing for intermediate glow that is executed by the electronic control unit configuring the glow plug drive control system shown in FIG. 1;

FIG. 4 is a schematic diagram schematically showing an example configuration of a post glow voltage decision-use map in the embodiment of the present invention; and

FIG. 5 is an explanatory diagram describing a basic method of driving a common glow plug.

### DETAILED DESCRIPTION OF THE PREFERRED EMBODIMENTS

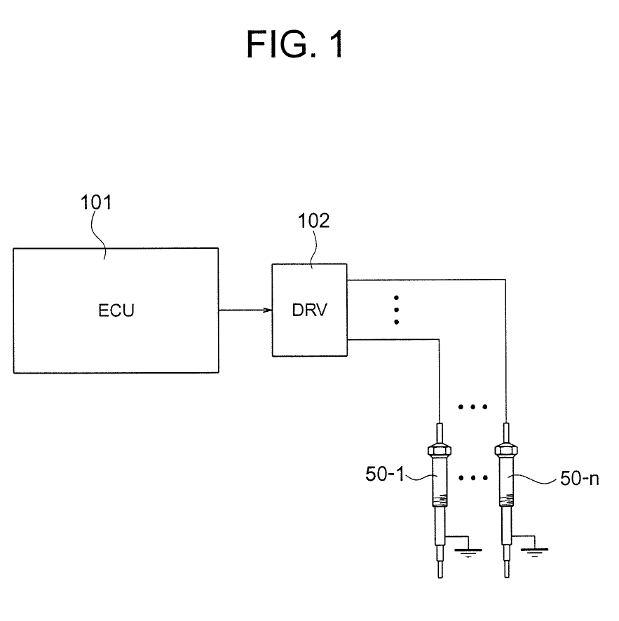

An embodiment of the invention will be described below with reference to FIG. 1 to FIG. 5.

It will be noted that the members and arrangements described below are not intended to limit the present invention and can be variously modified within the scope of the gist of the present invention.

First, an example configuration of a glow plug drive control system to which glow plug drive control methods in the embodiment of the present invention are applied will be described with reference to FIG. 1.

The glow plug drive system in the embodiment of the present invention is broadly divided into and configured by an electronic control unit (abbreviated as “ECU” in FIG. 1) 101 and an energization circuit (abbreviated as “DRV” in FIG. 1) 102.

The electronic control unit 101 is, for example, configured to have a microcomputer (not shown) having a publicly-known/well-known configuration as a main component, storage elements (not shown) such as a RAM and a ROM, and an input/output interface circuit (not shown) for sending and receiving signals to and from an external circuit, and the electronic control unit 101 executes vehicle engine control, fuel injection control, and later-described glow plug drive control processing.

The energization circuit 102 has a publicly-known/well-known configuration for performing energization of glow plugs 50-1 to 50-n in response to glow plug drive control by the electronic control unit 101.

The glow plugs 50-1 to 50-n are disposed in correspondence to the number of cylinders of an unillustrated engine and are configured such that one end of a heating element (not shown) disposed inside each of the glow plugs is connected to an output stage of the energization circuit 102 and such that the other end side of the heating element is connected to a ground (grounded to a vehicle body). In the embodiment of the present invention, in particular, ceramic glow plugs are used for the glow plugs 50-1 to 50-n.

That is, a ceramic glow plug has a ceramic heater where a heating element comprising an electrically conductive ceramic is disposed inside a round bar-shaped member comprising an insulating ceramic.

In the description below, the glow plugs 50-1 to 50-n will be called ceramic glow plugs 50-1 to 50-n.

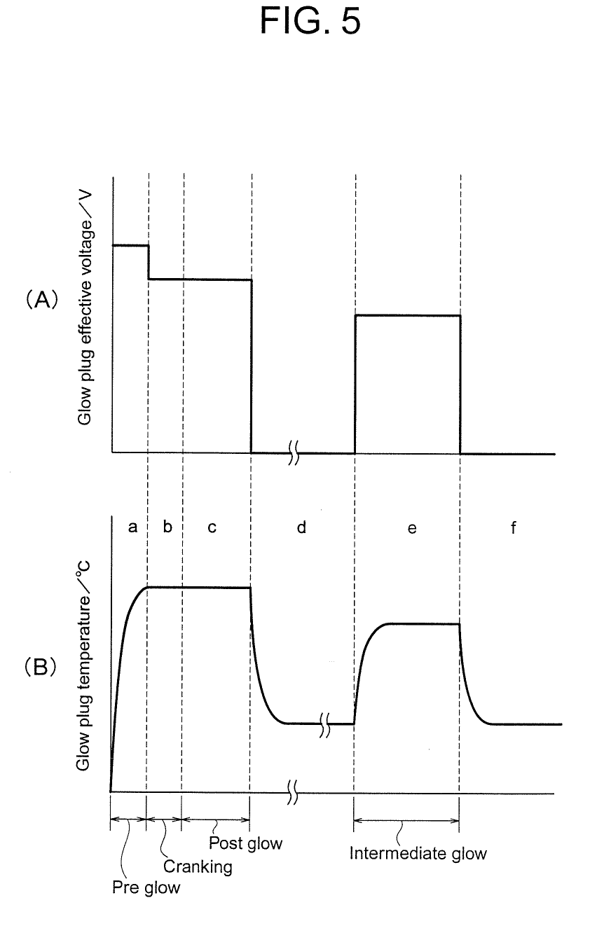

Next, conventional glow plug drive control will be generally described with reference to FIG. 5.

Generally, glow plug driving is broadly divided into: first, a drive period called pre glow before the engine starts (the period denoted by reference sign a in FIG. 5(B)); next, a drive period called start glow at the time when cranking starts (the period denoted by reference sign b in FIG. 5(B)); next, a drive period called post glow for combustion stabilization after the end of cranking (the period denoted by reference sign c in FIG. 5(B)); and a period in which the driving of the glow plugs accompanying combustion stabilization is stopped (the period denoted by reference sign d in FIG. 5(B)).

Additionally, even after the driving of the glow plugs accompanying combustion stabilization is stopped, sometimes there are also disposed a drive period called intermediate glow in which the glow plugs are driven as needed, that is, for example, for reducing emissions and regenerating a DPF (black smoke filter) of an exhaust gas recirculation system (the period denoted by reference sign e in FIG. 5(B)) and a period in which the driving of the glow plugs is stopped (the period denoted by reference sign f in FIG. 5(B)).

FIG. 5(A) shows an example of the change in the voltage that is applied to the glow plugs in each of the drive period described above, and the voltage applied to the glow plugs is set to be highest during pre glow.

The glow plug drive control methods in the embodiment of the present invention relate to a drive control method in post glow and a drive control method in intermediate glow. These drive control methods were created as a result of extensive research by the present inventors particularly from the standpoint of suppressing, without sacrificing the maximum temperature of the heater portions, ceramic glow plug deterioration caused by changes in the cooling state of ceramic glow plugs inside the engine combustion chamber. Here, “cooling state” means the cooling state of the ceramic glow plugs resulting from a swirl arising inside the combustion chamber of the engine (not shown).

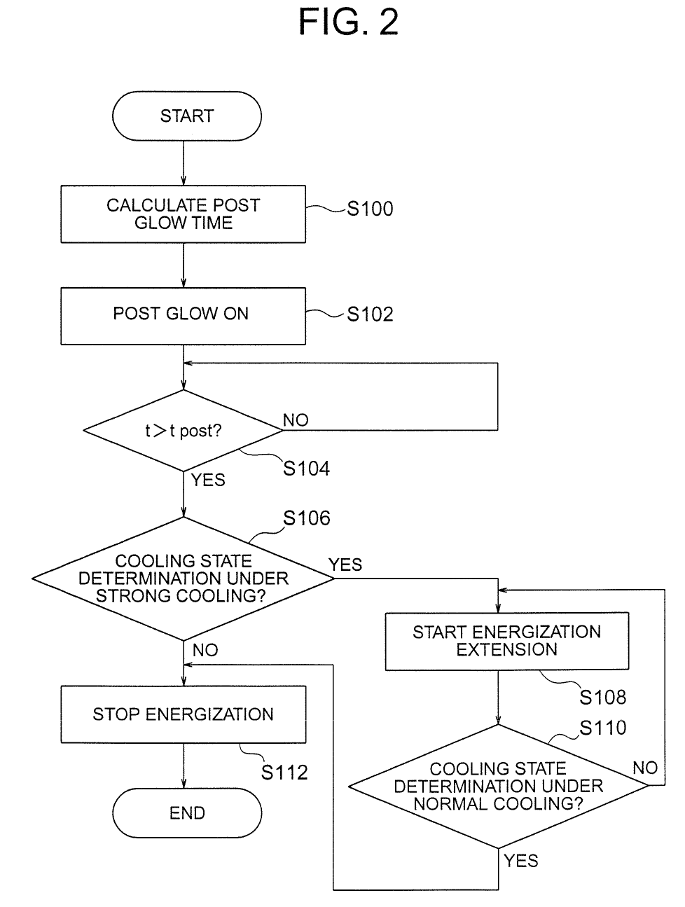

In FIG. 2, a procedure of the glow plug drive control processing for post glow that is executed by the electronic control unit 101 is shown in a sub-routine flowchart, and the content of that processing will be described with reference to the same drawing.

When the processing is started by the electronic control unit 101, first, calculation of a required post glow time tₚₒₛₜ is performed under the current engine operating situation (see step S100 in FIG. 2). That is, specifically, the post glow time tₚₒₛₜ is calculated using a preset arithmetic expression or map search on the basis of data of preset plural elements among various elements that affect control of the operation of the engine (not shown) (hereinafter, these elements will be called “engine drive control elements”) such as the engine cooling water temperature and the atmospheric pressure, for example. Here, the data such as the engine cooling water temperature and the atmospheric pressure are detected by unillustrated sensors and are used in engine operation control processing that is executed in a main routine (not shown), so it suffices for these to be read and appropriated in step S100.

After the post glow time tₚₒₛₜ has been calculated as described above, a post glow voltage is decided, energization of the ceramic glow plugs 50-1 to 50-n is started by the energization circuit 102 using that voltage, and post glow is executed (post glow ON) (see step S102 in FIG. 2).

That is, in the embodiment of the present invention, the post glow voltage is decided using a preset post glow voltage decision-use map described next.

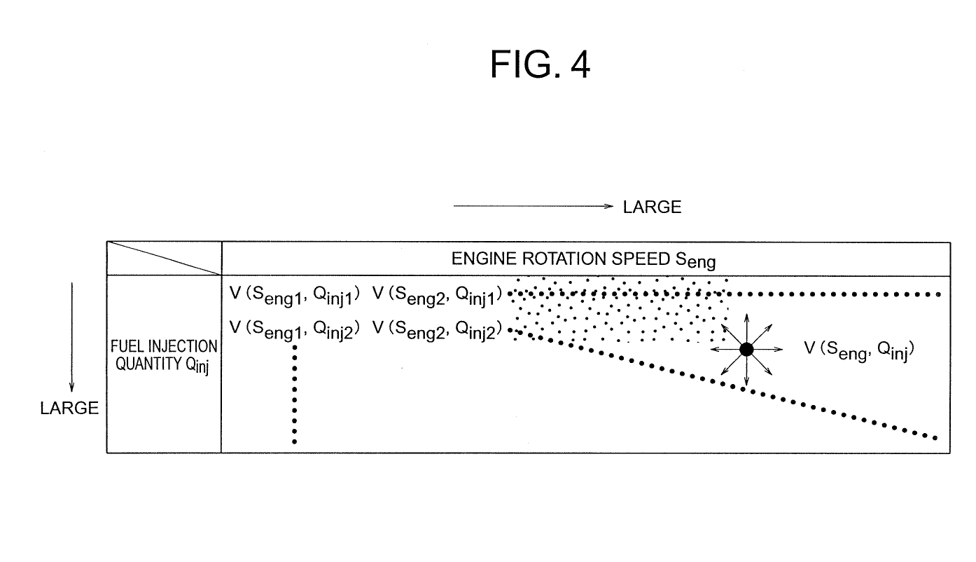

The post glow voltage decision-use map in the embodiment of the present invention is configured such that, as shown in FIG. 4, post glow voltages are decided using an engine rotation speed S_{eng} and a fuel injection quantity Qᵢₙⱼ as parameters; in the drawing, “V” represents post glow voltages so that, for example, V (S_{eng}1, Qᵢₙⱼ1) expediently represents a post glow voltage in a case where the engine rotation speed is S_{eng}1 and the fuel injection quantity is Qᵢₙⱼ1. The other places in FIG. 4 are also to be interpreted in accordance with this.

The engine rotation speed S_{eng} is calculated by a predetermined arithmetic expression from the frequency of the rotation of the engine, which is detected by an unillustrated sensor. Further, the fuel injection quantity Qᵢₙⱼ is a target fuel injection quantity that is calculated by a predetermined arithmetic expression on the basis of data such as the frequency of the rotation of the engine and the accelerator pedal position. The engine rotation speed S_{eng} and the fuel injection quantity Qᵢₙⱼ are, like the engine cooling water and the like mentioned before, used in the engine operation control processing that is executed in the main routine (not shown), so it suffices for these to be read and appropriated.

The post glow voltages in this post glow voltage decision-use map are decided in consideration of cooling states of the ceramic glow plugs 50-1 to 50-n on the basis of simulations and tests.

That is, the rough state of the magnitude of the cooling state of the ceramic glow plugs 50-1 to 50-n in the combustion chamber of the engine (not shown)—in other words, the cooling quantity resulting from swirl cooling—can be estimated using the engine rotation speed S_{eng} and the fuel injection quantity Qᵢₙⱼ, so in the embodiment of the present invention, the post glow voltage is decided on the basis of simulations and tests in response to this estimated cooling state.

In FIG. 4, the shaded range is a region where the cooling state of the ceramic glow plugs 50-1 to 50-n is particularly harsh (a strong cooling region), that is, in other words, a region where the swirl cooling quantity is particularly large, and the portion surrounding that region is a region where the cooling state is a normal cooling state (a normal cooling region).

In this manner, the post glow voltage decision-use map in the embodiment of the present invention can also be seen as a map that represents the extent of the harshness of the cooling condition of the ceramic glow plugs 50-1 to 50-n using the engine rotation speed S_{eng} and the fuel injection quantity Qᵢₙⱼ as parameters.

Energization by the energization circuit 102 with respect to the ceramic glow plugs 50-1 to 50-n using the post glow voltage obtained as described above is, in the embodiment of the present invention, energization by PWM control like conventionally. For that reason, the post glow voltages in FIG. 4 are given by effective values. Further, in FIG. 4, duty ratios at the time of energization by PWM control may also be used instead of post glow voltages.

When it is determined that the calculated post glow time tₚₒₛₜ has elapsed after post glow has been started (see step S102 in FIG. 2) as described above (see step S104 in FIG. 4), then it is determined whether or not the cooling state is in a state of continuance for a first predetermined amount of time t1 or longer under strong cooling (see step S106 in FIG. 2).

That is, whether or not the cooling state inside the engine combustion chamber (not shown) in other words, a region where the swirl cooling quantity is particularly large—is in the strong cooling region (a predetermined strong cooling state) shown in FIG. 4, for a predetermined amount of time or longer is determined from the engine rotation speed S_{eng} and the fuel injection quantity Qᵢₙⱼ at this point in time using the post glow voltage decision-use map shown in FIG. 4.

Then, in step S106, when it has been determined that the cooling state is in the strong cooling region for the first predetermined amount of time t1 or longer (in the case of YES), the flow advances to the processing of step S108 described later, and when it has been determined that the cooling state is not in a state where it is in the strong cooling region for the first predetermined amount of time t1 or longer (in the case of NO), energization of the ceramic glow plugs 50-1 to 50-n is stopped, the series of processing is ended, and the flow returns to the unillustrated main routine (see step S112 in FIG. 2).

Here, the reason energization is stopped when it has been determined that the cooling state is not in a state where it is in the strong cooling region for the first predetermined amount of time t1 or longer is based on the research results of the present inventors, which is that, in this case, there is less deterioration of the ceramic glow plugs 50-1 to 50-n thought to be caused by thermal stress than in the case where energization is stopped when the cooling state is in the strong cooling region.

In step S108, based on the determination that the ceramic glow plugs 50-1 to 50-n are in the strong cooling region for the first predetermined amount of time t1 or longer (see step S106 in FIG. 2), the cooling state is regarded as being unsuitable for stopping energization, and energization extension is performed.

That is, first, a voltage at the time of post glow extended energization (hereinafter called an “extension voltage”) Vₚₒₛₜ₋ₑₓₜ is obtained using a predetermined post glow extension voltage-use map. Then, energization of the ceramic glow plugs 50-1 to 50-n is extended by the energization circuit 102 using the obtained extension voltage Vₚₒₛₜ₋ₑₓₜ.

As mentioned before, in the embodiment of the present invention, energization of the ceramic glow plugs 50-1 to 50-n is performed by PWM control, so what is actually obtained using the post glow extension voltage-use map is a duty ratio at the time of energization.

Further, the predetermined post glow extension voltage-use map is a map where extension voltages Vₚₒₛₜ₋ₑₓₜ are decided in consideration of cooling states of the ceramic glow plugs 50-1 to 50-n using the engine rotation speed S_{eng} and the fuel injection quantity Qᵢₙⱼ as parameters and specifically is set using basically the same way of thinking as the post glow voltage decision-use map described before. Consequently, this post glow extension voltage-use map is a map where V (S_{eng}, Qᵢₙⱼ) in FIG. 4 is replaced with Vₚₒₛₜ₋ₑₓₜ (S_{eng}, Qᵢₙⱼ) and the strong cooling region also is the same region as described before in FIG. 4.

It is suitable for the individual extension voltages Vₚₒₛₜ₋ₑₓₜ in this post glow extension voltage-use map to be decided on the basis of simulations and test results.

Further, predetermined voltages may also be used instead of deciding the extension voltages Vₚₒₛₜ₋ₑₓₜ using the post glow extension voltage-use map as described above.

Then, the post glow extended energization is continued until it is determined that the cooling state of the ceramic glow plugs 50-1 to 50-n inside the engine combustion chamber (not shown) is in the normal cooling region for a second predetermined amount of time t2 or longer (see step S110 in FIG. 2), and when it has been determined that the cooling state is in the normal cooling region for the second predetermined amount of time t2 or longer, energization of the ceramic glow plugs 50-1 to 50-n is stopped (see step S112 in FIG. 2). In this manner, the reason energization is stopped after the cooling state has transitioned to the normal cooling state and that state has continued for the second predetermined amount of time t2 or longer is, just as was described before in the condition (step S106 in FIG. 2) when energization is stopped without extended energization, to suppress deterioration of the plugs 50-1 to 50-n caused by thermal stress by stopping energization when the cooling state reaches a state where thermal stress is abated.

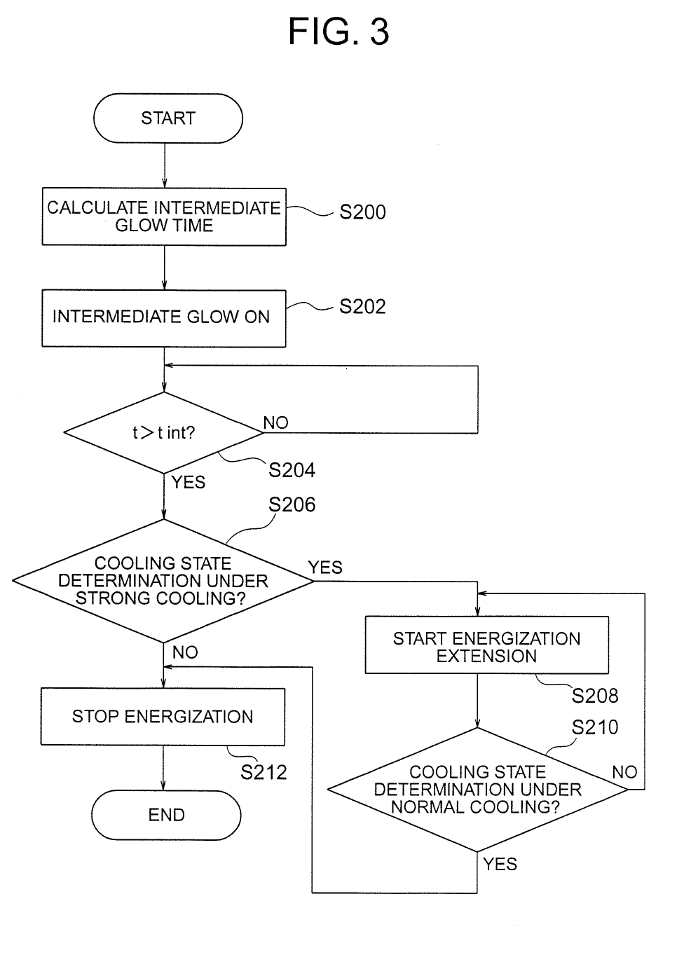

Next, in FIG. 3, a procedure of the glow plug drive control processing for intermediate glow is shown in a sub-routine flowchart, and the content of that processing will be described below with reference to the same drawing.

When the processing is started by the electronic control unit 101, first, calculation of an intermediate glow time tᵢₙₜ is performed (see step S200 in FIG. 2).

Here, in the embodiment of the present invention, the intermediate glow time tᵢₙₜ is calculated by a predetermined arithmetic expression on the basis of the atmospheric temperature and the differential pressure of the DPF. The atmospheric pressure and the differential pressure of the DPF are detected by unillustrated sensors and are used in the engine operation control processing that is executed in the main routine (not shown), so it suffices for these to be appropriated in step S200.

After the intermediate glow time tᵢₙₜ, has been calculated as described above, an intermediate glow voltage Vᵢₙₜ is decided, energization of the ceramic glow plugs 50-1 to 50-n is started by the energization circuit 102 using that voltage, and intermediate glow is executed (intermediate glow ON) (see step S202 in FIG. 3).

Here, the intermediate glow voltage Vᵢₙₜ is decided using a preset intermediate glow voltage decision-use map described next.

The intermediate glow voltage decision-use map in the embodiment of the present invention is configured such that intermediate glow voltages are decided in consideration of cooling states of the ceramic glow plugs 50-1 to 50-n using the engine rotation speed S_{eng} and the fuel injection quantity Qᵢₙⱼ as parameters and specifically is set using basically the same way of thinking as the post glow voltage decision-use map described before. Consequently, this intermediate glow voltage decision-use map is a map where V (S_{eng}, Qᵢₙⱼ) in FIG. 4 is replaced with Vᵢₙₜ (S_{eng}, Qᵢₙⱼ), and the strong cooling region also is the same region as described before in FIG. 4. It is suitable for the individual intermediate glow voltages Vᵢₙₜ in this intermediate glow voltage decision-use map to be decided on the basis of simulations and test results.

When it is determined that the calculated intermediate glow time tᵢₙₜ has elapsed after intermediate glow has been started (see step S202 in FIG. 3) as described above (see step S204 in FIG. 3), then it is determined whether or not the cooling state of the ceramic glow plugs 50-1 to 50-n is in a state of continuance for a third predetermined amount of time t3 or longer under strong cooling (see step S206 in FIG. 3).

Here, whether or not the cooling state is under strong cooling is decided using the intermediate glow voltage decision-use map from the engine rotation speed S_{eng}, and the fuel injection quantity Qᵢₙⱼ at this point in time. That is, the intermediate glow voltages Vᵢₙₜ in the intermediate glow voltage decision-use map correspond to cooling states of the ceramic glow plugs 50-1 to 50-n in the combustion chamber of the engine (not shown), so the place in the intermediate glow voltage decision-use map where the engine rotation speed S_{eng} and the fuel injection quantity Qᵢₙⱼ at this point in time are positioned represents the cooling state just as described before in the post glow voltage decision-use map (see FIG. 4), and whether or not they are in the strong cooling region (the predetermined strong cooling state) of the intermediate glow voltage decision-use map can be determined.

Then, in step S206, when it has been determined that the cooling state is in the strong cooling region for the third predetermined amount of time t3 or longer (in the case of YES), the flow advances to the processing of step S208 described later, and when it has been determined that the cooling state is not in a state where it is in the strong cooling region for the third predetermined amount of time t3 or longer (in the case of NO), energization of the ceramic glow plugs 50-1 to 50-n is stopped, the series of processing is ended, and the flow returns to the unillustrated main routine (see step S212 in FIG. 3).

Here, the reason energization is stopped when it has been determined that the cooling state is not in a state where it is in the strong cooling region for the third predetermined amount of time t3 or longer is because it is thought that thermal stress applied to the ceramic glow plugs 50-1 to 50-n is smaller in this case than in the case where energization is stopped when the cooling state is in the strong cooling region.

In step S208, based on the determination that the ceramic glow plugs 50-1 to 50-n are in the strong cooling region for the third predetermined amount of time t3 or longer (see step S206 in FIG. 3), the cooling state is regarded as being unsuitable for stopping energization, and intermediate glow energization extension is performed.

That is, first, a voltage at the time of extended energization (hereinafter called an “extension voltage”) Vᵢₙₜ₋ₑₓₜ is obtained using a predetermined intermediate glow extension voltage-use map. Then, energization of the ceramic glow plugs 50-1 to 50-n is extended by the energization circuit 102 using the obtained extension voltage Vᵢₙₜ₋ₑₓₜ. Here, the predetermined intermediate glow extension voltage-use map is, just as was described before in step S108 in FIG. 2, set basically using the same way of thinking as the post glow voltage decision-use map, so detailed description again here will be omitted.

Then, the intermediate glow extended energization is continued until it is determined that the cooling state of the ceramic glow plugs 50-1 to 50-n inside the engine combustion chamber (not shown) is in the normal cooling region for a fourth predetermined amount of time t4 or longer (see step S210 in FIG. 3), and when it has been determined that the cooling state is in the normal cooling region for the fourth predetermined amount of time t4 or longer, energization of the ceramic glow plugs 50-1 to 50-n is stopped (see step S212 in FIG. 3).

In this manner, the reason energization is stopped after the cooling state has transitioned to the normal cooling state and that state has continued for the fourth predetermined amount of time t4 or longer is for the same reason as was described before in step S110.

In the embodiment of the present invention, the glow plug drive control methods have been described as ceramic glow plug drive control methods, but the drive control methods are not limited to glow plugs and can be similarly applied to heating means that use a ceramic heater and have a structure similar to glow plugs and where the cooling state of the surrounding area at the time of use varies.

Further, in the embodiment of the present invention, the timing when the flow advances to the substantial processing of energization control is decided using time (see steps S100 and S104 in FIG. 2 and steps S200 and S204 in FIG. 3), but an element other than time may also be used. For example, it is also suitable for the flow to advance to the processing for switching OFF energization (the processing from step S106 onward in FIG. 2 or the processing from step S206 onward in FIG. 3) when the engine has entered a certain operating state.

Thermal stress is alleviated and reliability is improved without sacrificing the required maximum temperature, and the invention can be applied to glow plugs that aid the starting of diesel engines and the like that require good temperature characteristics and reliability.

According to the present invention, the invention achieves the effects that when energization of the heating element ends, when it is determined that the cooling state resulting from cooling wind from the surrounding area is in a state where it has escaped from the relatively most intense region using predetermined parameters as an indicator, energization is stopped, so thermal stress resulting from the temperature difference between the inside and the outside of the member housing the heating element is alleviated, deterioration caused by thermal stress is suppressed, and the life-span of the glow plug can be extended.

Further, because thermal stress is alleviated without having to regulate the maximum temperature of the glow plug, reliable control of toxic components in exhaust gas resulting from intermediate glow and the like becomes possible particularly in glow plugs used in vehicles, and exhaust gas regulations can be accommodated at a low cost.

Moreover, because glow plug deterioration is reliably suppressed, it becomes possible to reliably avoid state of deterioration such as the occurrence of cracks, which can contribute to improving reliability.

What is claimed is:

1. A glow plug drive control method that controls the energization of a glow plug, wherein at a time when post glow of the glow plug ends, when it has been determined that a cooling state inside a combustion chamber of an engine is not in a predetermined strong cooling state for a first predetermined amount of time or longer, post glow energization is stopped.

2. The glow plug drive control method according to claim 1, wherein the predetermined strong cooling state is a state where a swirl cooling quantity is in a particularly large region.

3. The glow plug drive control method according to claim 2, wherein whether or not the cooling state is the state where the swirl cooling quantity is in the particularly large region is decided from the engine rotation speed and the fuel injection quantity at the time of determination on the basis of a preset correlative relationship between at least the engine rotation speed and the fuel injection quantity and the swirl cooling quantity.

4. The glow plug drive control method according to claim 3, wherein
when it has been determined that the cooling state inside the combustion chamber of the engine is in the predetermined strong cooling state for the first predetermined amount of time or longer, a preset post glow extension voltage-use map is used to obtain a voltage when extending post glow energization, and post glow energization extension is started using the obtained voltage,
thereafter, when it has been determined that the cooling state inside the combustion chamber of the engine is transitioning from the predetermined strong cooling state to an abated state over a second predetermined amount of time or longer, the post glow energization extension is stopped,
when it has been determined that the cooling state inside the combustion chamber of the engine is not in a state where it has transitioned from the predetermined strong cooling state to the abated state over the second predetermined amount of time or longer, the post glow extension voltage-use map is used to obtain a post glow energization extension voltage, and extending post glow energization using the obtained voltage is repeated, and
the post glow extension voltage-use map is configured so as to be capable of reading, using the engine rotation speed and the fuel injection quantity as parameters, voltages for extending post glow energization that have been set in response to cooling states inside the combustion chamber of the engine that are set on the basis of at least the engine rotation speed and the fuel injection quantity.

5. A glow plug drive control method that controls the energization of a glow plug, wherein at a time when intermediate glow of the glow plug ends, when it has been determined that a cooling state inside a combustion chamber of an engine is not in a predetermined strong cooling state for a third predetermined amount of time or longer, intermediate glow energization is stopped.

6. The glow plug drive control method according to claim 5, wherein the predetermined strong cooling state is a state where a swirl cooling quantity is in a particularly large region.

7. The glow plug drive control method according to claim 6, wherein whether or not the cooling state is the state where the swirl cooling quantity is in the particularly large region is decided from the engine rotation speed and the fuel injection quantity at the time of determination on the basis of a preset correlative relationship between at least the engine rotation speed and the fuel injection quantity and the swirl cooling quantity.

8. The glow plug drive control method according to claim 7, wherein
when it has been determined that the cooling state inside the combustion chamber of the engine is in the predetermined strong cooling state for the third predetermined amount of time or longer, a preset intermediate glow extension voltage-use map is used to obtain a voltage when extending intermediate glow energization, and intermediate glow energization extension is started using the obtained voltage,
thereafter, when it has been determined that the cooling state inside the combustion chamber of the engine is transitioning from the predetermined strong cooling state to an abated state over a fourth predetermined amount of time or longer, the intermediate glow energization extension is stopped,
when it has been determined that the cooling state inside the combustion chamber of the engine is not in a state where it has transitioned from the predetermined strong cooling state to the abated state over the fourth predetermined amount of time or longer, the intermediate glow extension voltage-use map is used to obtain an intermediate glow energization extension voltage, and extending intermediate glow energization using the obtained voltage is repeated, and
the intermediate glow extension voltage-use map is configured so as to be capable of reading, using the engine rotation speed and the fuel injection quantity as parameters, voltages for extending intermediate glow energization that have been set in response to cooling states inside the combustion chamber of the engine that are set on the basis of at least the engine rotation speed and the fuel injection quantity.

9. A glow plug drive control system comprising:
an electronic control unit that executes drive control of a glow plug; and
an energization circuit that performs energization of the glow plug according to the glow plug drive control executed by the electronic control unit,
wherein the electronic control unit is configured such that at a time when post glow of the glow plug ends, when it has been determined that a cooling state inside a combustion chamber of an engine is not in a predetermined strong cooling state for a first predetermined amount of time or longer, the electronic control unit causes the energization circuit to stop post glow energization.

10. The glow plug drive control system according to claim 9, wherein the predetermined strong cooling state is a state where a swirl cooling quantity is in a particularly large region.

11. The glow plug drive control system according to claim 10, wherein the electronic control unit is configured to decide whether or not the cooling state is the state where the swirl cooling quantity is in the particularly large region from the engine rotation speed and the fuel injection quantity at the time of determination on the basis of a preset correlative relationship between at least the engine rotation speed and the fuel injection quantity and the swirl cooling quantity.

12. The glow plug drive control system according to claim 11, wherein
the electronic control unit is configured such that
when it has been determined that the cooling state inside the combustion chamber of the engine is in the predetermined strong cooling state for the first predetermined amount of time or longer, the electronic control unit uses a preset post glow extension voltage-use map to obtain a voltage when extending post glow energization and causes the energization circuit to start post glow energization extension using the obtained voltage,
thereafter, when it has been determined that the cooling state inside the combustion chamber of the engine is transitioning from the predetermined strong cooling state to an abated state over a second predetermined amount of time or longer, the electronic control unit causes the post glow energization extension to stop, and
when it has been determined that the cooling state inside the combustion chamber of the engine is not in a state where it has transitioned from the predetermined strong cooling state to the abated state over the second predetermined amount of time or longer, the electronic control unit uses the post glow extension voltage-use map to obtain a post glow energization extension voltage and repeats causing the energization circuit to extend post glow energization using the obtained voltage, and
the post glow extension voltage-use map is configured so as to be capable of reading, using the engine rotation speed and the fuel injection quantity as parameters, voltages for extending post glow energization that have been set in response to cooling states inside the combustion chamber of the engine that are set on the basis of at least the engine rotation speed and the fuel injection quantity.

13. A glow plug drive control system comprising:
an electronic control unit that executes drive control of a glow plug; and
an energization circuit that performs energization of the glow plug according to the glow plug drive control executed by the electronic control unit,
wherein the electronic control unit is configured such that at a time when intermediate glow of the glow plug ends, when it has been determined that a cooling state inside a combustion chamber of an engine is not in a predetermined strong cooling state for a third predetermined amount of time or longer, the electronic control unit causes the energization circuit to stop intermediate glow energization.

14. The glow plug drive control system according to claim 13, wherein the predetermined strong cooling state is a state where a swirl cooling quantity is in a particularly large region.

15. The glow plug drive control system according to claim 14, wherein the electronic control unit is configured to decide whether or not the cooling state is the state where the swirl cooling quantity is in the particularly large region from the engine rotation speed and the fuel injection quantity at the time of determination on the basis of a preset correlative relationship between at least the engine rotation speed and the fuel injection quantity and the swirl cooling quantity.

16. The glow plug drive control system according to claim 15, wherein
the electronic control unit is configured such that
when it has been determined that the cooling state inside the combustion chamber of the engine is in the predetermined strong cooling state for the third predetermined amount of time or longer, the electronic control unit uses a preset intermediate glow extension voltage-use map to obtain a voltage when extending intermediate glow energization and causes the energization circuit to start intermediate glow energization extension using the obtained voltage,
thereafter, when it has been determined that the cooling state inside the combustion chamber of the engine is transitioning from the predetermined strong cooling state to an abated state over a fourth predetermined amount of time or longer, the electronic control unit causes the intermediate glow energization extension to stop, and
when it has been determined that the cooling state inside the combustion chamber of the engine is not in a state where it has transitioned from the predetermined strong cooling state to the abated state over the fourth predetermined amount of time or longer, the electronic control unit uses the intermediate glow extension voltage-use map to obtain an intermediate glow energization extension voltage and repeats causing the energization circuit to extend intermediate glow energization using the obtained voltage, and
the intermediate glow extension voltage-use map is configured so as to be capable of reading, using the engine rotation speed and the fuel injection quantity as parameters, voltages for extending intermediate glow energization that have been set in response to cooling states inside the combustion chamber of the engine that are set on the basis of at least the engine rotation speed and the fuel injection quantity.
